(19) United States
(12) Patent Application Publication
(10) Pub. No.: US 2019/0017180 A1
(43) Pub. Date: Jan. 17, 2019

(54) PHOTOCATHODE FOR A PHOTOELECTROLYSIS DEVICE, METHOD FOR PRODUCING SUCH A PHOTOCATHODE, AND PHOTOELECTROLYSIS DEVICE

(71) Applicants: TOTAL RAFFINAGE CHIMIE, Courbevoie (FR); SORBONNE UNIVERSITE, Paris 6 (FR); COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(72) Inventors: Johanna TOUPIN, Paris (FR); Vincent ARTERO, Quaix en Chartreuse (FR); Christel LABERTY-ROBERT, Paris (FR)

(73) Assignees: TOTAL RAFFINAGE CHIME, Courbevoie (FR); SORBONNE UNIVERSITE, Paris 6 (FR); COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(21) Appl. No.: 16/067,689

(22) PCT Filed: Jan. 4, 2017
(86) PCT No.: PCT/EP2017/050123

§ 371 Date: Jul. 2, 2018

(30) Foreign Application Priority Data
Jan. 4, 2016 (FR) 1650018

(51) Int. Cl. C25B 1/00; H01G 9/20; C25B 11/04

(52) U.S. Cl. CPC C25B 1/003; C25B 11/0405; H01G 9/2027

(57) ABSTRACT

A photocathode for a photoelectrolysis device, including: a substrate; a layer of a metal conductor arranged on the substrate; at least one first layer of a first, p-type semiconductor arranged on the layer of metal conductor; at least one second layer of a second p-type semiconductor arranged on the first layer of the first, p-type semiconductor; and at least one third layer of a third, n-type semiconductor forming a protective layer and arranged on the second layer of the second, p-type semiconductor, the third layer of the third, n-type semiconductor being stable in aqueous media to prevent contact between an aqueous electrolyte and the first and second layers of the first and second, p-type semiconductors and including a material of ABO₃ material, wherein A is selected from Ca, Sr and Ba and B is selected from Ti, Fe.

The invention relates to a photocathode for a photoelectrolysis device, to a process for manufacturing such a photocathode and to a photoelectrolysis device and more broadly to photoelectrolysis.

Hydrogen technologies are increasingly popular due to the generally nonpolluting or not very polluting nature thereof.

These technologies are usually based on the generation of electricity from hydrogen in order to drive, for example, electric motors, in particular electric motors of a motor vehicle, by means of a fuel cell operating with hydrogen.

Specifically, the emissions from such a fuel cell are nonpolluting since the reaction of dihydrogen and dioxygen produces only water within the fuel cell.

However, the success of this promising technology depends for the most part on the way in which the dihydrogen is produced, both in terms of cost and in ecological terms.

Specifically, the dihydrogen produced by electrolysis is currently very expensive and the ecological nature thereof depends on the way in which the electricity used to supply an electrolyzer has been produced.

Other production methods, for example by natural gas reforming, are less expensive but have a significant ecological impact.

Using electricity produced by renewable energy (for example by photovoltaic panels, wind turbines or hydroelectric power plants) for the production of the dihydrogen may appear attractive, but a calculation of the total and economic efficiency over the entire combustion generation chain makes it possible to understand the limits of such an approach currently.

Another way to produce dihydrogen 100% ecologically and more simply consists in carrying out an electrolysis of water via solar energy, more specifically the direct photoelectrolysis of water.

Fujishima and Honda (“Electrochemical Photolysis of Water at a Semiconductor Electrode,” Nature, vol. 238, pp. 37-38, 1972) published for the first time in 1972 in the journal Nature an article describing an electrochemical cell composed of a photoanode, an n-type semiconductor, rutile phase TiO₂, and a platinum cathode. When it was exposed to the sun, this cell was capable of carrying out the electrolysis of water. They thus showed that it was possible to produce dihydrogen directly from solar energy, namely to convert this energy into storable chemical energy. Since these first studies, many articles have been published on photoelectrochemical conversion and storage but few relate to the device in its entirety.

Photoelectrolysis is an electrolysis which directly uses light. Indeed, it is a process that makes it possible to convert light into electrochemical potential, then into chemical energy, as is observed during the photosynthesis of green plants. This is why this type of reaction is referred to as “artificial photosynthesis”.

There are several types of possible configurations for a photoelectrochemical cell having one or two photoelectrodes, and various positionings of the electrodes relative to the light radiation (see for example N. Queyriaux, N. Kaeffer, A. Morozan, M. Chavarot-Kerlidou, and V. Artero, “Molecular cathode and photocathode materials for hydrogen evolution in photoelectrochemical devices,” J. Photochem. Photobiol. C Photochemistry Reviews. 20:15, 25, 90-105).

Photons from the light are absorbed by the electrons of the valence band of the photoanode, and an exciton (or electron-hole pair) is then generated. An electron, after absorption of a photon that is energetic enough to enable it to jump the band gap, then passes from the valence band to the conduction band. A hole is therefore simultaneously created in the valence band.

The holes reach the surface where they react with the water molecules present in the electrolyte.

For their part, the photogenerated electrons pass from the conduction band via an external circuit into the valence band of the photocathode, thus creating a photocurrent.

In order to produce a photocathode for photoelectrolysis, it is known to use copper (I) oxide, Cu₂O, also referred to as cuprous oxide or cuprite (natural state). Indeed, copper oxide Cu₂O is known to be a p-type semiconductor material.

However, copper oxide, like many materials, also has limitations, such as in particular photocorrosion problems.

The strategy for preventing any contact between the semiconductor and the electrolyte is to add a protective layer on the semiconductor.

Thus, various materials have been, and are currently being, studied for acting as protection for the copper oxide, such as CuO (Z. Zhang and P. Wang, “Highly stable copper oxide composite as an effective photocathode for water splitting via a facile electrochemical synthesis strategy,” J. Mater. Chem., vol. 22, no. 6, pp. 2456-2464, 2012), TiO₂ (W. Siripala, A. Ivanovskaya, T. F. Jaramillo, S. H. Baeck, and E. W. McFarland, “A Cu₂O/TiO₂ heterojunction thin film cathode for photoelectrocatalysis,” Sol. Energy Mater. Sol. Cells, vol. 77, no. 3, pp. 229-237, 2003), NiO. (C.-Y. Lin, Y.-H. Lai, D. Mersch, and E. Reisner, “Cu₂O|NiOx nanocomposite as an inexpensive photocathode in photoelectrochemical water splitting,” Chem. Sci., vol. 3, no. 12, p. 3482, 2012.), C (Z. Zhang, R. Dua, L. Zhang, H. Zhu, H. Zhang, and P. Wang, “Carbon-layer-protected cuprous oxide nanowire arrays for efficient water reduction,” ACS Nano, vol. 7, no. 2, pp. 1709-1717, 2013), SrTiO₃ (I). Sharma, S. Upadhyay, V. R. Satsangi, R. Shrivastav, U. V. Waghmare, and S. Dass, “Improved Photoelectrochemical Water Splitting Performance of Cu₂O/SrTiO3 Heterojunction Photoelectrode,” J. Phys. Chem. C, vol. 118, no. Ii, pp. 25320-25329, 2014) for example.

Although an improvement, especially in the stability of the photocathode in aqueous media was able to be observed, this was achieved in certain cases to the detriment of the efficiency.

The present invention aims to propose a photocathode for a photoelectrochemical cell which has sufficient stability, in particular over time, and insofar as possible for an enlarged pH range and an improved efficiency.

For this purpose, one subject of the invention is a photocathode for a photoelectrolysis device, comprising:
a substrate,
a layer of a metallic conductor placed on the substrate,
at least one first layer of a p-type first semiconductor placed on the metallic conductor layer,
at least one second layer of a p-type second semiconductor placed on the first layer of the p-type first semiconductor,
at least one third layer of an n-type third semiconductor forming a protective layer and placed on the second layer of the p-type second semiconductor, the third layer of the n-type third semiconductor being stable in aqueous media so as to prevent contact between an aqueous electrolyte and the first and second layers of the p-type first and second. semiconductors and being composed of a material of ABO₃ type, where A is chosen from Ca, Sr and Ba and B is chosen from Ti, Fe,
the energy of the bottom of the conduction band of the p-type first semiconductor being greater than the energy of the bottom of the conduction band of the p-type second semiconductor, and
the energy of the bottom of the conduction band of the p-type second semiconductor being greater than the energy of the bottom of the conduction band of the n-type third semiconductor.

According to other features, taken alone or in combination:

According to one aspect, the energy of the bottom of the conduction band of the n-type third semiconductor is greater than the energy for reduction of protons to give dihydrogen.

According to another aspect, the conductor layer placed on the substrate is copper.

The p-type first semiconductor is for example Cu₂O and the p-type second semiconductor is CuO.

The n-type third semiconductor may he BaTiO₃.

The substrate is for example glass covered with a transparent conductor, in particular an FTO glass.

Provision may be made for the thickness of the conductor layer to be between 5 μm and 15 μm, especially between 8 μm and 12 μm, in particular 10 μm.

The thickness of the first layer of the p-type first semiconductor is for example between 30 μm and 50 μm, especially between 35 μm and 45 μm, in particular 40 μm.

The thickness of the second layer of the p-type second semiconductor may be between 0.5 μm and 3 μm, especially between 1 μm and 2 μm, in particular 1.5 μm.

The thickness of the third layer of the n-type third semiconductor is for example between 150 nm and 350 nm, especially between 200 nm and 300 nm, in particular 250 nm.

According to yet another aspect, the width of the band gap of the first semiconductor is greater than the width of the band gap of the second semiconductor.

The invention also relates to a process for manufacturing a photocathode as defined above, wherein the photocathode is produced by successive deposition of the various layers, in particular by chemical vapor deposition.

The invention also relates to a process for manufacturing a photocathode as defined above, wherein the p-type first and second semiconductors are oxides of the metal forming the metallic conductor layer,

a metallic conductor layer is deposited on the substrate,

the first layer of the p-type first semiconductor and the second layer of the p-type second semiconductor are produced by calcination, and

the third layer of the n-type third semiconductor is deposited on the second layer of the p-type second semiconductor.

According to one aspect, the metal forming the metallic conductor is copper and the calcination is carried out under an air atmosphere at a temperature of between 240° C. and 260° C., especially 250° C., for a duration of between 25 min and 35 min, in particular 30 min.

According to another aspect, the third layer of the n-type third semiconductor is deposited by a sol-gel route coupled with a dip-coating method.

The calcination takes place for example in dry air for a time of between 30 min and 2 h, more particularly one hour and at a temperature of between 550° C. and 770° C., more particularly 600° C. for BaTiO₃ in order to crystallize it.

Provision may be made, before the deposition of the conductor layer, for a reduction treatment to be carried out on the substrate.

Finally, the invention relates to a photoelectrolysis device characterized in that it comprises a photocathode as defined above.

Other advantages and features will become apparent on reading the description of the following figures, among which:

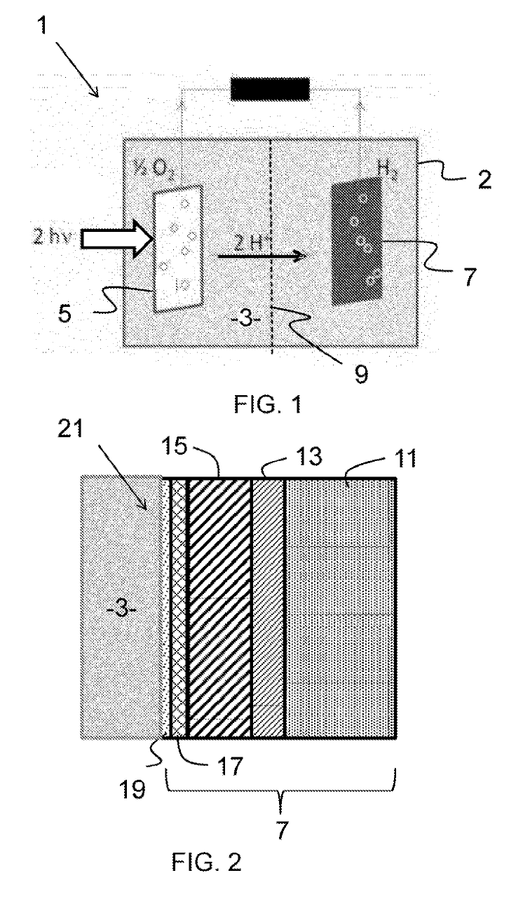

FIG. 1 is a general diagram of a photoelectrolysis device,

FIG. 2 is a simplified diagram of the layers of a photocathode according to one embodiment,

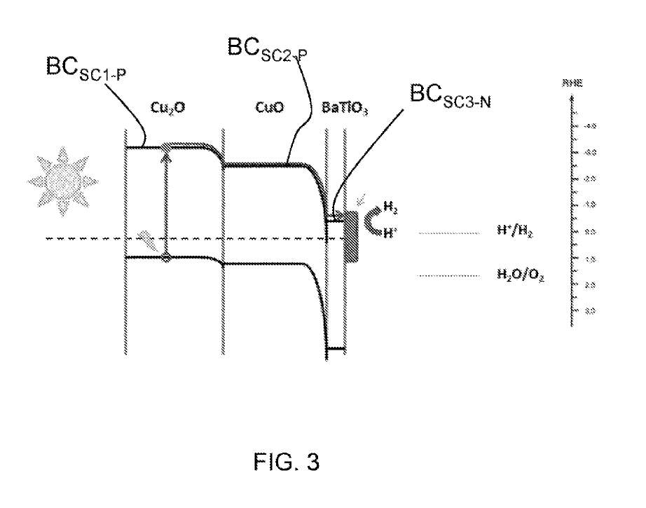

FIG. 3 is a diagram of the patterns of bands of a photocathode according to one embodiment,

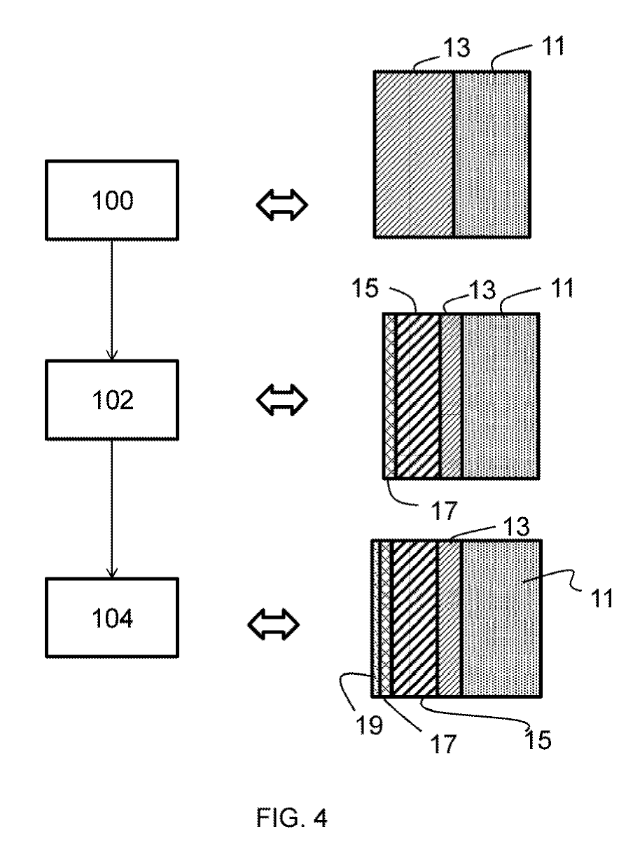

FIG. 4 is a diagram of one embodiment of a process for manufacturing a photocathode according to the invention,

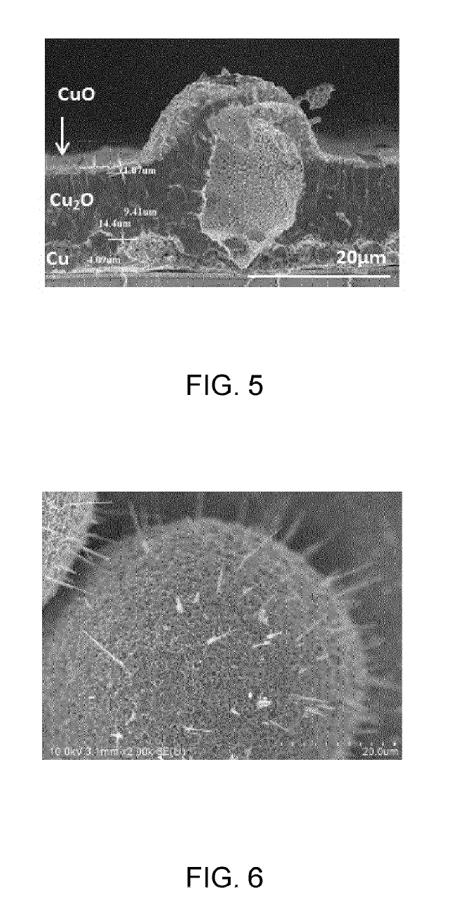

FIG. 5 is a scanning electron microscope image of a photocathode after an intermediate step of the manufacturing process,

FIG. 6 is a scanning electron microscope image of a photocathode after the final step of the manufacturing process,

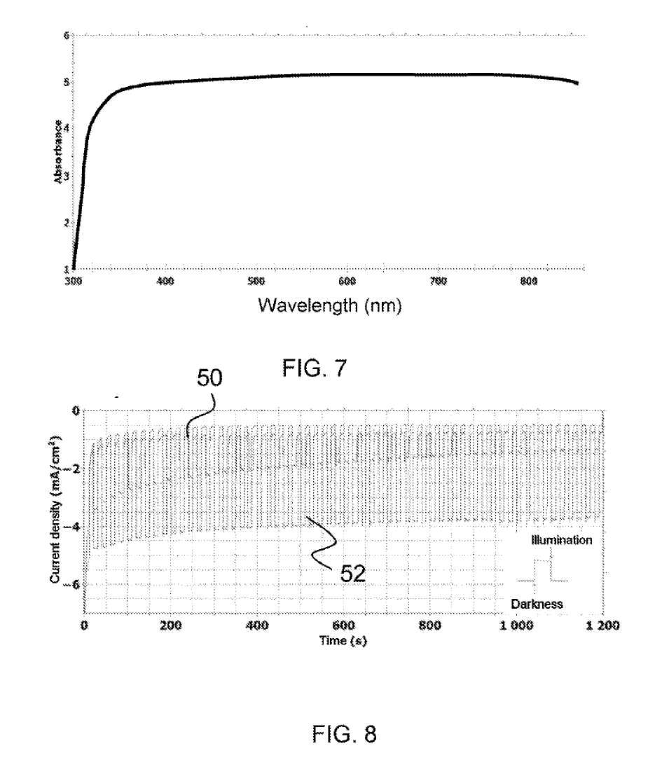

FIG. 7 shows on a graph the absorbance of an example of a photocathode according to the invention as a function of the wavelength, and

FIG. 8 is a chronoamperometry diagram.

In all the figures, the same references relate to the same elements.

The following embodiments arc examples. Although the description refers to one or more embodiments, this does not necessarily mean that each reference relates to the same embodiment, or that the features apply only to a single embodiment. Simple features of various embodiments may also be combined or interchanged in order to provide other embodiments.

FIG. 1 shows a diagram of a photoclectrolysis device 1 according to the invention. Such a device 1 is also referred to as a photoelectrochemical cell and comprises a chamber 2 filled with water 3 as electrolyte, two photoelectrodes 5 and 7 for example in the form of plates, a photoanode 5 which is an n-type semiconductor, and a photocathode 7 which is a p-type semiconductor. The electrolyte may also contain a phosphate buffer (PBS) or Na₂SO₄ buffer dissolved in water.

The two photoelectrodes 5 and 7 are separated by a proton-exchange membrane 9 (for example a membrane made of C₇HF₁₃O₅S.C₂F₄ sold under the registered trademark Nafion™) inserted between the two photoelectrodes 5 and 7.

According to the general diagram, the semiconductors absorb the solar energy (2hν), then generating a voltage necessary for decomposing the water.

Specifically, the photons of light are absorbed by the electrons of the valence band of the photoanode 5, and an exciton (or electron-hole pair) is then generated. An electron, after absorption of a photon that is energetic enough to enable it to jump the hand gap, then passes from the valence band to the conduction band. A hole is therefore simultaneously created in the valence band.

The holes reach the surface where they react with the water molecules of the electrolyte 3. These molecules are thus oxidized to give dioxygen and protons, according to the following equation:

2H₂O+4h⁺⇄O₂+4H⁺(E_{OX}⁰=1.23V vs NHE at pH 0).

The photogenerated electrons pass from the conduction band via an external circuit into the valence band of the photocathode, thus creating a photocurrent.

At the same time, at the photocathode 7, when it is illuminated, electron-hole pairs are also formed. The difference with the photoanode 5 is that this time it is the electrons that go to the semiconductor/electrolyte interface in order to reduce the protons H⁺, resulting from the oxidation of the water at the photoanode 5 and diffusing through the electrolyte 3 and the membrane 9, to give dihydrogen, according to the equation:

4H⁺+4e⁻⇄2H₂(E_{RED}⁰=0V vs NHE in acid medium).

FIG. 2 shows various layers of an example of a photocathode 7 according to the invention.

Thus, the photocathode 7 comprises
a substrate 11,
a layer 13 of a metallic conductor placed on the substrate 11,
at least one first layer 15 of a p-type first semiconductor placed on the metallic conductor layer 13,
at least one second layer 17 of a p-type second semiconductor placed on the first layer 15 of the p-type first semiconductor,
at least one third layer 19 of an n-type third semiconductor forming a protective layer and placed on the second layer 17 of the p-type second semiconductor.

The substrate layer 11 is for example FTO glass, that is to say glass covered with fluorine-doped tin dioxide, and acts as support for the whole photocathode 7.

The metallic conductor layer 13 is for example made of copper Cu.

The thickness of the metallic conductor layer 13 is between 5 μm and 15 μm, especially between 8 μm and 12 μm, in particular 10 μm.

Next, the layer 15 of the p-type first semiconductor is made of Cu₂O. The thickness of the first layer 15 of the p-type first semiconductor is between 30 μm and 50 μm, especially between 35 μm and 45 μm, in particular 40 μm.

But of course, other p-type semiconductors can be envisaged without departing from the scope of the present invention.

Next, the layer 17 of the p-type second semiconductor is for example made of CuO. The thickness of the second layer 17 of the p-type second semiconductor is between 0.5 μm and 3 μm, especially between 1 μm and 2 μm, in particular 1.5 μm.

But of course, other p-type semiconductors can be envisaged without departing from the scope of the present invention.

The fact of combining the layers 13 made of Cu, 15 made of Cu₂O and 17 made of CuO makes it possible to absorb photons that then photogencrate electrons over a broader wavelength range, especially in the visible range, up to close to 900 nm. Indeed, the width of the band gap of the Cu₂O first semiconductor is greater than the width of the band gap of the CuO second semiconductor. The absorption bands of the two p-type semiconductors are therefore partly complementary.

The small band gap width of CuO (around 1.5 eV) thus adds, relative to the Cu₂O, an additional range of absorption toward larger wavelengths in the red and near infrared ranges.

As can be seen in FIG. 3, so that the photogenerated electrons can easily migrate to the surface 21 (FIG. 2) of the photocathode 7, the energy of the bottom of the conduction band of the p-type first semiconductor BC_{SC1-P} (for “band of conduction of the first semiconductor of p-type”) is greater than the energy of the bottom of the conduction band of the p-type second semiconductor BC_{C2-P}, which is the case with the layers 15 made of Cu₂O and 17 made of CuO.

But of course, other p-type semiconductors can be envisaged without departing from the scope of the present invention if this relationship between the energies of the bottom of the conduction band of the first and second semiconductors is respected.

The layer 19 of the n-type third semiconductor is a protective layer and, as such, it is stable in aqueous media so as to prevent contact between an aqueous electrolyte 3 and the layers 15 and 17 of the p-type first and second semiconductors.

The layer 19 is for example composed of a material of ABO₃ type, where A is chosen from Ca, Sr and Ba and Bis chosen from Ti, Fe.

The thickness of the third layer 19 of the n-type third semiconductor is between 150 nm and 350 nm, especially between 200 nm and 300 nm, in particular 250 nm. Indeed, this third layer 19 must be thick enough to properly protect the layers 15 and 17 from the electrolyte 3 but also thin enough to allow the migration of the photogenerated electrons to the surface 21 of the photocathode 7 in order to enable the recombination of the protons H⁺ to give dihydrogen H₂ molecules.

For this reason, the energy of the bottom of the conduction band of the p-type second semiconductor BC_{SC2-P} is greater than the energy of the bottom of the conduction band of the n-type third semiconductor BC_{SC3-N} (see FIG. 3).

Furthermore, the energy of the bottom of the conduction band of the n-type third semiconductor BC_{SC3-N} is greater than the energy for reduction of protons to give dihydrogen.

FIG. 3 shows a diagram of the patterns of bands in the case where the layer 19 of the n-type third semiconductor is BaTiO₃.

It is therefore understood that the photocathode 7 according to the invention improves the amount of electrons photogenerated by a broader absorption range, while favoring, via a “toboggan” effect for the photogenerated electrons owing to the gradually decreasing energy of the bottom of the conduction bands of the various layers 15, 17 and 19, the migration of the electrons to the surface 21 of the photocathode 7. Furthermore, the photocathode 7 is well protected against deterioration by the electrolyte 3 by the protective layer 19 formed for example of BaTiO₃.

Another advantage of the photocathode having layers 13, 15 and 17 respectively made of Cu, Cu₂O, CuO comes down to the fact that this sequence of layers can be obtained by the deposition of copper followed by treatments, for example calcination, on the deposited metal layer, which is simple, inexpensive and ecologically favorable.

In greater detail, FIG. 4 gives details of the various steps of a process for manufacturing a photocathode 7 wherein the p-type first and second semiconductors are oxides of the metal forming the metallic conductor layer.

Thus, according to a step 100, a metallic conductor layer 13 is deposited on the substrate 11.

In order to promote the adhesion of the metallic conductor on the substrate 11, it is possible, before the deposition of the conductor layer, to carry out a reduction treatment on the substrate 11.

Next, according to a step 102, the first layer 15 of the p-type first semiconductor and the second layer 17 of the p-type second semiconductor are produced by a partial calcination of the metallic conductor layer 13.

In the case where the metal forming the metallic conductor is copper, the calcination is carried out under an air atmosphere at a temperature of between 240° C. and 260° C., especially 25° C., for a duration of between 25 min and 35 min, in particular 30 min.

Finally, the third layer 19 of the n-type third semiconductor is deposited on the second layer 17 of the p-type second semiconductor.

The third layer 19 of the n-type third semiconductor is for example deposited by a sol-gel route coupled with a dip-coating method.

### EXAMPLES

In a first phase, the electrodes composed of copper oxide(s) are synthesized; then, the materials that will act as protection will be deposited in a second phase.

1) Synthesis and Deposition of the Copper Oxides

The formation of the films of copper oxides may be carried out by a sol-gel route or by electrodeposition-anodization of the copper.

1.1.) Formation of the Layers 15 and 17 of Copper Oxides by a Sol-Gel Route:

1.1.1) Dip Coating:

Using a sol composed of 1.75 g of CuCl₂.2H₂O in 5.5 g of methanol, five layers are deposited, by dip-coating, on a glass substrate covered with FTO (SnO₂:F) on one face, previously washed with ethanol.

Each layer is deposited in dry air (RH<5%) at a speed of 3.5 mm/s and a one-minute heat treatment at 450° C. is carried out between each layer.

1.1.2) Calcination: in Air for 30 min at 450° C.

1.2) Formation of the Layers 15 and 17 of Copper Oxides by Electrodeposition-anodization of the Copper:

1.2.1) Reduction of the FTO:

Use is made of a 250 ml solution with 0.01 M of Na₂SO₄.10H₂O and 0.1 M of H₂ SO₄ in which a cathode current at the FTO of 25 mA/cm² is applied for 20 sec. The substrates used for this type of synthesis are different from the glass/FTO substrates used during the sol-gel synthesis. Specifically, this synthesis route requires an FTO layer having a lower resistivity (7 Ω).

1.2.2) Electrodeposition:

A 0.8 M acid solution of copper sulfate, i.e. 63.92 g of Cu(SO₄) and 22.5 g of H₂SO₄topped up with distilled water to obtain a total volume of 500 ml, is prepared. The copper layer 13 is electrodeposited on the substrate at (−)220 mA/cm² (with a copper counterelectrode) for between 10 min and 30 min, then the electrode is rinsed with distilled water.

1.2.3) Anodization:

A 1 M solution of sodium hydroxide, i.e. 20 g of NaOH in 500 ml of distilled water, is prepared. The electrodeposited copper layer 13 is now anodized at 0.5 mA/cm² for between 10 min and 30 min, then the electrode is rinsed with distilled water.

1.2.4) Calcination:

In air for 30 min at a temperature of around 250° C. in order to form the layers 15 made of Cu₂O and 17 made of Cu.

2) Synthesis and Deposition of the Protection:

The protective layer 19, for example made of BaTiO₃, is then deposited on the surface of one or the other of the two types of electrode based on copper oxide(s).

The barium titanate can be synthesized by various routes. One possible route is the sol-gel route coupled with dip-coating, since the chemical process may be described as mild, simple, inexpensive and easily adaptable to the industrial scale. The composition of the sol for obtaining BaTiO₃ is given as follows:

BaTiO₃

1.42 g Ba(OH)₂•7H₂O
6 g glacial acetic acid
9 g absolute ethanol
0.36 g acetylacetone
1.36 g titanium isopropoxide

The layer 19 of is deposited, for example in two passes, from sols, the composition of which is indicated in the table above, on the electrodes composed of copper oxide(s). A one-minute heat treatment at 400° C. is carried out between each pass deposited in order to stabilize them. Finally, the calcination takes place in dry air for a time of between 30 min and 2 h, more particularly one hour at a temperature of between 550° C. and 770° C., more particularly 600° C. for BaTiO₃ in order to crystallize it. One advantageous case is a calcination at 600° C. for one hour.

Of course, it is also possible to manufacture a photocathode as described with reference to FIGS. 1 to 3 by a successive deposition of the various layers, in particular by chemical vapor deposition.

FIG. 5 shows a scanning electron microscope image of a photocathode after step 102.

It is seen therein that the surface has a particular structure composed of a continuum composed successively of the layers of Cu, Cu₂O and CuO; and also hollow halls due to the release of dihydrogen during the electrodeposition of the copper. This is advantageous, since this makes it possible to maximize the electrode/electrolyte interface, which is the site of the reaction between the protons of the electrolyte and the electrons of the electrode. Furthermore, this also makes it possible to minimize the journey of the electrons photogenerated within the photocathode 7 to the interface with the electrolyte.

These balls are themselves singular since they have needles over their entire surface.

The formation of the needles could be linked to the reaction at the Cu₂O/CuO interface which produces a compressive stress in the CuO layer and which leads to the diffusion of the copper cations along the CuO grain boundaries, resulting in a growth of needles on the CuO grains. Thus, the existing CuO grains act as support for initiating the growth of the CuO needles. Specifically, the copper cations diffusing along the grain boundaries are deposited on the top of the grains via surface diffusion. This diffusion is driven by the concentration gradients of Cu ions between the grain boundaries, the junction zone, and the root of the nanowires.

The thickness of the CuO layer from which the growth of the needles/nanowires begins is around 1 μm.

FIG. 6 shows a scanning electron microscope image of a photocathode after step 104.

The protective layer 19 made of BaTiO₃ uniformly covers the entire surface of the copper-based electrodes. Furthermore, the deposition of BaTiO₃ only slightly impairs the surface of the Cu/Cu₂O/CuO electrodes. CuO needles are still present even though most have been broken during the deposition by dip-coating in BaTiO₃.

The thickness of the BaTiO₃ layers is negligible in view of the thickness of the copper oxides. Specifically, it is of the order of 200-300 nm, whereas that of CuO is between 1 and 2 μm, and that of Cu₂O is of the order of 40 μm and that of Cu is around 10 μm for a sample electrodeposited. over 20 min and anodized for the same duration.

FIG. 7 shows, by way of example, the absorbance of a Cu/Cu₂O/CuO/BaTiO₃ photocathode. It is seen that the absorbance is virtually stable over a wide range of wavelengths extending from around 370 nm to 900 nm. The lower absorbance in the UV results rather from an uncorrected artefact of the measurement device and should be higher than shown on the graph.

FIG. 8 shows two chronoamperometry curves: a curve 50 for a Cu/Cu₂O/CuO photocathode not protected by a protective layer 19, and a curve 52 for a Cu/Cu₂O/CuO photocathode according to an example of embodiment of the present invention.

Chronoamperometry is carried out at 0 V vs RHE, pH 6, alternating the periods in darkness and under illumination at a frequency of 0.1 Hz.

For the curve 50, it is seen that the absolute value decreases as a function of the time. This is due to the photocorrosion of the copper oxides to copper metal; thus the electrodes are deactivated over time, copper metal not being a photoelectrode.

For the curve 52 with the protective layer 19, on the one hand the photocurrent value is increased and on the other hand the photostability, which remains virtually stable over time, is greatly increased.

The electric field created at the p-n junction between the copper oxide (CuO) and the barium titanate makes it possible to better separate the photogenerated charges and therefore to limit electron-hole recombinations. This phenomenon, with the addition of a better absorbance of the photocathode 7 protected by a layer 19, makes it possible to explain the increase in photocurrent of the protected electrodes. Furthermore, the comparison of the photocurrent values between the start of the chronoamperometry and after 20 min of alternation between darkness and illumination, shows that the photo stability of the unprotected electrodes is between 47% and 60%, whereas that of the electrodes protected by BaTiO₃ is greater than 89%. The layer 19 of BaTiO₃ indeed covers the whole surface of the Cu/Cu₂O/CuO electrodes; thus since the latter are no longer in contact with the electrolyte, they no longer undergo photocorrosion, whereas the electrons indeed continue to be transferred to the electrode/electrolyte interface in order to reduce the protons present within the electrolyte to give dihydrogen, which explains the better photostability observed.

It is therefore understood that the photocathodes 7 according to the invention enable a better efficiency and display greater stability over time.

1-18 (canceled)

19. A photocathode for a photoelectrolysis device, comprising:
a substrate;
a layer of a metallic conductor placed on the substrate;
at least one first layer of a p-type first semiconductor placed on the metallic conductor layer;
at least one second layer of a p-type second semiconductor placed on the first layer of the p-type first semiconductor;
at least one third layer of an n-type third semiconductor forming a protective layer and placed on the second layer of the p-type second semiconductor, the third layer of the n-type third semiconductor being stable in aqueous media to prevent contact between an aqueous electrolyte and the first and second layers of the p-type first and second semiconductors and including a material of ABO₃, wherein A is chosen from Ca, Sr and Ba and B is chosen from Ti, Fe;
energy of the bottom of the conduction band of the p-type first semiconductor being greater than the energy of the bottom of the conduction band of the p-type second semiconductor, and
energy of the bottom of the conduction band of the p-type second semiconductor being greater than the energy of the bottom of the conduction band of the n-type third semiconductor.

20. The photocathode as claimed in claim 19, wherein the energy of the bottom of the conduction band of the n-type third semiconductor is greater than the energy for reduction of protons to give dihydrogen.

21. The photocathode as claimed in claim 19, wherein the conductor layer placed on the substrate is copper.

22. The photocathode as claimed in claim 19, wherein the p-type first semiconductor is Cu₂O and the p-type second semiconductor is CuO.

23. The photocathode as claimed in claim 19, wherein the n-type third semiconductor is BaTiO₃.

24. The photocathode as claimed in claim 19, wherein the substrate is glass covered with a transparent conductor, or an FTO glass.

25. The photocathode as claimed in claim 19, wherein thickness of the conductor layer is between 5 μm and 15 μm.

26. The photocathode as claimed in claim 19, wherein thickness of the first layer of the p-type first semiconductor is between 30 μm and 50 μm.

27. The photocathode as claimed in claim 19, wherein thickness of the second layer of the p-type second semiconductor is between 0.5 μm and 3 μm.

28. The photocathode as claimed in claim 19, wherein thickness of the third layer of the n-type third semiconductor is between 150 nm and 350 nm.

29. The photocathode as claimed in claim 19, wherein width of the band gap of the first semiconductor is greater than the width of the band gap of the second semiconductor.

30. A process for manufacturing a photocathode as claimed in claim 19, wherein the photocathode is produced by successive deposition of the various layers, or by chemical vapor deposition.

31. A process for manufacturing a photocathode as claimed in claim 19, wherein the p-type first and second semiconductors are oxides of the metal forming the metallic conductor layer;
a metallic conductor layer is deposited on the substrate;
the first layer of the p-type first semiconductor and the second layer of the p-type second semiconductor are produced by calcination, and
the third layer of the n-type third semiconductor is deposited on the second layer of the p-type second semiconductor.

32. The process as claimed in claim 31, wherein the metal forming the metallic conductor is copper and the calcination is carried out under an air atmosphere at a temperature of between 240° C. and 260° C., for a duration of between 25 min and 35 min.

33. The process as claimed in claim 31, wherein the third layer of the n-type third semiconductor is deposited by a sol-gel route coupled with a dip-coating method.

34. The process as claimed in claim 31, wherein a calcination of the n-type third semiconductor is carried out in dry air for a time of between 30 min and 2 h, and at a temperature of between 550° C. and 770° C., to crystallize the n-type third semiconductor.

35. The process as claimed in claim 30, wherein, before the deposition of the conductor layer, a reduction treatment is carried out on the substrate.

36. A photo electrolysis device, comprising a photocathode as claimed in claim 19.
